(19) United States
(12) Patent Application Publication
(10) Pub. No.: US 2023/0168912 A1
(43) Pub. Date: Jun. 1, 2023

(54) SYSTEM AND METHOD FOR UPGRADING A MANAGEMENT COMPONENT OF A COMPUTING ENVIRONMENT USING HIGH AVAILABILITY FEATURES

(71) Applicant: VMWARE, INC., Palo Alto, CA (US)

(72) Inventors: Sandeep Sinha, Bangalore (IN); Akash Kodenkiri, Bangalore (IN); Chandrika Mutalik, Bangalore (IN)

(21) Appl. No.: 17/668,404

(22) Filed: Feb. 10, 2022

(30) Foreign Application Priority Data
Nov. 30, 2021 (IN) 202141055478

(51) Int. Cl. G06F 9/455; G06F 9/48

(52) U.S. Cl. CPC G06F 9/45558; G06F 9/4881; G06F 9/45545; G06F 2009/4557

(57) ABSTRACT

A system and method for upgrading a source management component of a computing environment uses a target management component that is deployed in a host computer of the computing environment. The source and target management components are set as a primary-secondary management pair for a high availability system such that the source management component is set as a primary protected component and the target management component is set as a secondary unprotected component. After services of the source management component are stopped and the target management component is powered on, the primary-secondary management pair is modified to switch the source management component to the secondary unprotected component and the target management component to the primary protected component. Services of the target management component are then started to take over responsibilities of the source management component.

### RELATED APPLICATION

Benefit is claimed under 35 U.S.C. 119(a)-(d) to Foreign Application Serial No. 202141055478 filed in India entitled “SYSTEM AND METHOD FOR UPGRADING A MANAGEMENT COMPONENT OF A COMPUTING ENVIRONMENT USING HIGH AVAILABILITY FEATURES”, on Nov. 30, 2021, by VMware, Inc., which is herein incorporated in its entirety by reference for all purposes.

### BACKGROUND

Various computing architectures can be deployed in a public cloud as a cloud service. As an example, one or more software-defined data centers (SDDCs) may be deployed in a dedicated private cloud environment of a public cloud for an entity or customer via a cloud service provider, where each SDDC may include one or more clusters of host computers. Such dedicated private cloud environments may be managed by a cloud service provider, which uses a public cloud operated by a public cloud provider.

In a dedicated private cloud environment, there may be multiple management components that support the virtual infrastructure of the environment. For example, a dedicated private cloud environment may include a virtualization manager that manages a cluster of host computers and a software-defined network (SDN) manager that manages SDN components in the dedicated private cloud environment to provide logical networking services. If a management component needs to be upgraded, any service interruption due to the upgrade process should be minimized. In addition, any compute resources needed for the upgrade process should also be minimized.

### SUMMARY

A system and method for upgrading a source management component of a computing environment uses a target management component that is deployed in a host computer of the computing environment. The source and target management components are set as a primary-secondary management pair for a high availability system such that the source management component is set as a primary protected component and the target management component is set as a secondary unprotected component. After services of the source management component are stopped and the target management component is powered on, the primary-secondary management pair is modified to switch the source management component to the secondary unprotected component and the target management component to the primary protected component. Services of the target management component are then started to take over responsibilities of the source management component.

A computer-implemented method for upgrading a source management component of a computing environment in accordance with an embodiment of the invention includes deploying a target management component in a host computer of the computing environment, setting the source and target management components as a primary-secondary management pair for a high availability system such that the source management component is set as a primary protected component for the high availability system and the target management component is set as a secondary unprotected component for the high availability system, after setting the source and target management components as the primary-secondary management pair, stopping services of the source management component, powering on the target management component, after powering on the target management component, modifying the primary-secondary management pair to switch the source management component to the secondary unprotected component and the target management component to the primary protected component, and after modifying the primary-secondary management pair, starting services of the target management component to take over responsibilities of the source management component. In some embodiments, the steps of this method are performed when program instructions contained in a non-transitory computer-readable storage medium are executed by one or more processors.

A system in accordance with an embodiment of the invention comprises memory and at least one processor configured to deploy a target management component in a host computer of the computing environment, wherein the computing environment includes a source management component, set the source and target management components as a primary-secondary management pair for a high availability system such that the source management component is set as a primary protected component for the high availability system and the target management component is set as a secondary unprotected component for the high availability system, after the source and target management components are set as the primary-secondary management pair, stop services of the source management component, power on the target management component, after the target management component is powered on, modify the primary-secondary management pair to switch the source management component to the secondary unprotected component and the target management component to the primary protected component, and after the primary-secondary management pair is modified, start services of the target management component to take over responsibilities of the source management component.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

The embodiments of the invention are illustrated by way of example, and not by way of limitation, in the figures of the accompanying drawings in which:

FIG. 1 is a block diagram of a computing environment in accordance with an embodiment of the invention.

FIGS. 2A and 2B illustrate resource chunks that can be used to deploy a target virtual cluster manager (VCM) virtual machine (VM) in accordance with an embodiment of the invention.

FIGS. 3A-3G illustrate a source VCM and a target VCM during a VCM upgrade process in accordance with an embodiment of the invention.

FIG. 4 illustrates the various components of a three-node cluster in the computing environment that are involved in the VCM upgrade process in accordance with an embodiment of the invention.

FIG. 5 illustrates a process of upgrading the VCM in the computing environment in accordance with an embodiment of the invention.

FIG. 6 is a flow diagram illustrating a high availability (HA) initialize workflow in accordance with an embodiment of the invention.

FIG. 7 is a flow diagram illustrating an HA switchover workflow in accordance with an embodiment of the invention.

FIG. 8 is a process flow diagram of a computer-implemented method for upgrading a source management component of a computing environment in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

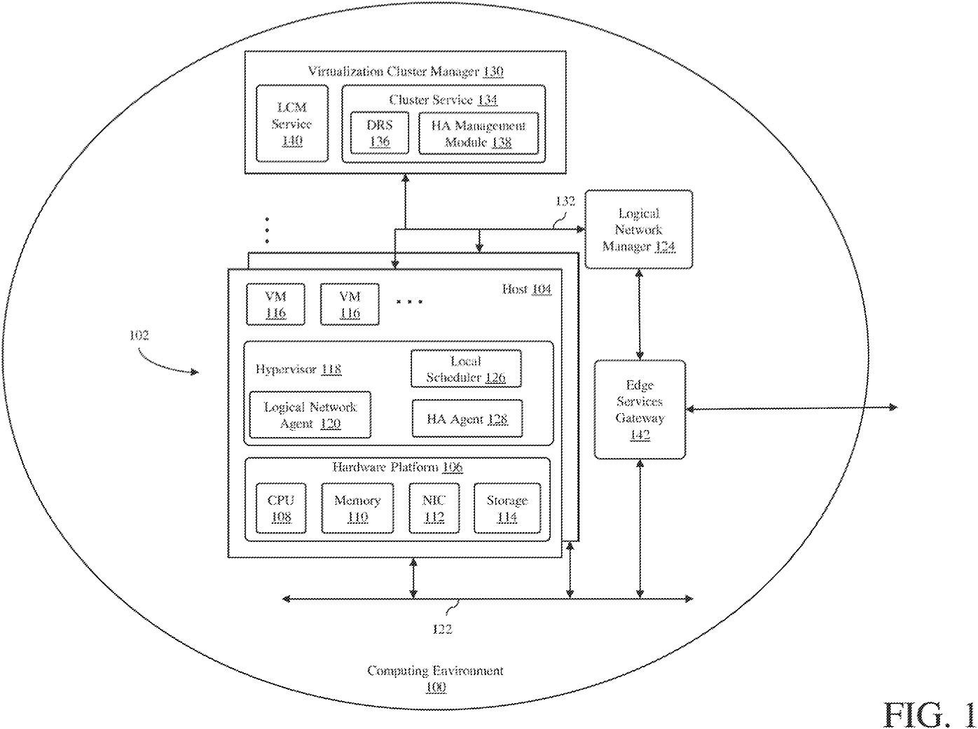

Turning now to FIG. 1, a computing environment 100 in accordance with an embodiment of the invention is illustrated. The computing environment 100 can be an on-premises computing environment or a cloud-based computing environment. As an example, the computing environment 100 may be a virtual private cloud (VPC), for example, a VMware Cloud, which is configured as a software-defined data center (SDDC) for use by a single tenant.

As shown in FIG. 1, the computing environment 100 includes a cluster 102 of host computers (“hosts”) 104. The hosts 104 may be constructed on a server grade hardware platform 106, such as an x86 architecture platform, which may be provided by a cloud provider of a public cloud on which the computing environment 100 is deployed. As shown, the hardware platform 106 of each host 104 may include conventional components of a computer, such as one or more processors (e.g., CPUs) 108, system memory 110, a network interface 112, and storage 114. The processor 108 can be any type of a processor commonly used in servers. The memory 110 is volatile memory used for retrieving programs and processing data. The memory 110 may include, for example, one or more random access memory (RAM) modules. The network interface 112 enables the host 104 to communicate with other devices that are inside or outside of the computing environment 100 via a communication network, such as a network 122. The network interface 112 may be one or more network adapters, also referred to as network interface cards (NICs). The storage 114 represents one or more local storage devices (e.g., one or more hard disks, flash memory modules, solid state disks and/or optical disks), which may be used to form a virtual storage area network (SAN).

Each host 104 may be configured to provide a virtualization layer that abstracts processor, memory, storage and networking resources of the hardware platform 106 into the virtual computing instances (VCIs), e.g., virtual machines (VMs) 116, that run concurrently on the same host. In the illustrated embodiment, the VMs 116 run on top of a software interface layer, which is referred to herein as a hypervisor 118, that enables sharing of the hardware resources of the host by the VMs. One example of the hypervisor 118 that may be used in an embodiment described herein is a VMware ESXi™ hypervisor provided as part of the VMware vSphere® solution made commercially available from VMware, Inc. The hypervisor 118 may run on top of the operating system of the host or directly on hardware components of the host. For other types of VCIs, the host may include other virtualization software platforms to support those VCIs, such as Docker virtualization platform to support “containers”. Although embodiments of the inventions may involve other types of VCIs, various embodiments of the invention are described herein as involving VMs.

In the illustrated embodiment, the hypervisor 118 includes a logical network (LN) agent 120, which operates to provide logical networking capabilities, also referred to as “software-defined networking” (SDN). Each logical network may include software managed and implemented network services, such as bridging, L3 routing, L2 switching, network address translation (NAT), and firewall capabilities, to support one or more logical overlay networks in the computing environment 100. The logical network agent 120 may receive configuration information from a logical network manager 124 (which may include a control plane cluster) and, based on this information, populates forwarding, firewall and/or other action tables for dropping or directing packets between the VMs 116 in the host 104, other VMs on other hosts, and/or other devices outside of the computing environment 100. Collectively, the logical network agent 120, together with other logical network agents on other hosts, according to their forwarding/routing tables, implement isolated overlay networks that can connect arbitrarily selected VMs with each other. Each VM may be arbitrarily assigned a particular logical network in a manner that decouples the overlay network topology from the underlying physical network. Generally, this is achieved by encapsulating packets at a source host and decapsulating packets at a destination host so that VMs on the source and destination can communicate without regard to the underlying physical network topology. In a particular implementation, the logical network agent 120 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols, such as stateless transport tunneling (STT), Network Virtualization using Generic Routing Encapsulation (NVGRE), or Geneve, instead of, or in addition to, VXLAN.

The hypervisor 118 further includes a local scheduler 126 and a high availability (HA) agent 128. As described in more detail below, the local scheduler 126 operates as a part of a resource scheduling system that provides load balancing among enabled hosts 104 in the cluster 102. The HA agent 128 operates as a part of a high availability system that provides high availability of select VMs running on the hosts 104 by monitoring the hosts 104 in the cluster 102, and in the event of a host failure, the VMs on the failed host are restarted on alternate hosts in cluster.

The computing environment 100 also includes a virtualization cluster manager (VCM) 130 that communicates with the hosts 104 via a management network 132. In an embodiment, the VCM 130 is a computer program that resides and executes in a computer system, such as one of the hosts 104, or in a virtual computing instance, such as one of the VMs 116 running on the hosts 104. One example of the VCM 130 is the VMware vCenter Server® product made available from VMware, Inc. In an embodiment, the VCM 130 is configured to carry out administrative tasks for the cluster 102 of hosts 104 that forms an SDDC, including managing the hosts in the cluster and managing the virtual machines running within each host in the cluster, as well as other tasks.

In the illustrated embodiment, the VCM 130 includes a cluster service 134, which contains a distributed resource scheduler (DRS) 136 and a high availability (HA) management module 138. One example of the cluster service 134 is the VXPD service found in the VMware vCenter Server® product made available from VMware, Inc. The DRS 136, which is the management component of the resource scheduling system, operates with the local schedulers 126 of the hosts 104 in the cluster 102 to provide resource scheduling and load balancing for the cluster 102. Thus, the DRS 136 with the help of the local schedulers 126 can provide host recommendations to place VMs for initial placement or load balancing. In addition, the DRS 136 can also enforce user-defined resource allocation polices. One example of the resource scheduling system is the VMware vSphere® Distributed Resource Scheduler™ system of the VMware vSphere® product made available from VMware, Inc.

The HA management module 138, which is the management component of the HA system, operates with the HA agents 128 of the hosts 104 in the cluster 102 to provide high availability for VMs running in the cluster 102. In a case of failover, the HA management module 138 with the help of the HA agents 128 can restart VMs on a failed host on other hosts in the cluster 102, e.g., on hosts recommended by the resource scheduling system, i.e., the DRS 136 and the local schedulers 126. In some embodiments, when a HA cluster of select hosts 104 is created, a single host is automatically elected as the primary host. The remaining hosts in the HA cluster are referred to herein as secondary hosts. Using its HA agent, the primary host communicates with the VCM 130 and monitors the state of all protected VMs and of the secondary hosts, i.e., the other hosts in the HA cluster. The HA agent of the primary host is referred to herein as the primary HA agent. One example of the HA system is the VMware vSphere® High Availability system of the VMware vSphere® product made available from VMware, Inc. In this example, the HA agents in the hosts are known as fault domain manager (FDM) agents.

The VCM 130 also includes a lifecycle management (LCM) service 140, which manages tasks related installing software in the cluster 102, maintaining it through updates and upgrades, and decommissioning it. As an example, the LCM service 140 may install hypervisors and firmware on new hosts in the cluster, and update or upgrade them when required. In addition, as described in more detail below, the LCM service 140 may orchestrate the process of upgrading the VCM 130.

As noted above, the computing environment 100 also includes the logical network manager 124 (which may include a control plane cluster), which operates with the logical network agents 120 in the hosts 104 to manage and control logical overlay networks in the computing environment. Logical overlay networks comprise logical network devices and connections that are mapped to physical networking resources, e.g., switches and routers, in a manner analogous to the manner in which other physical resources as compute and storage are virtualized. In an embodiment, the logical network manager 124 has access to information regarding physical components and logical overlay network components in the computing environment 100. With the physical and logical overlay network information, the logical network manager 124 is able to map logical network configurations to the physical network components that convey, route, and filter physical traffic in the computing environment 100. In one particular implementation, the logical network manager 124 is a VMware NSX® Manager™ product running on any computer, such as one of the hosts 104 or VMs 116 in the computing environment 100.

The computing environment 100 also includes an edge services gateway 142 to control network traffic into and out of the computing environment 100. One example of the edge services gateway 142 is VMware NSX® Edge™ product made available from VMware, Inc.

In an embodiment, each of the VCM 130, the logical network manager 124 and the edge services gateway 142 may be implemented in a virtual computing instance, e.g., a VM, running in the computing environment 100. In some embodiments, there may be multiple instances of the logical network manager 124 and the edge services gateway 142 that are deployed in multiple VMs running in the computing environment 100.

The management components in the computing environment 100, such as the VCM 130 and the logical network manager 124, may need to be upgraded periodically. Upgrade of these management components can introduce new features, fix bugs and errors, and improve the functionality of the computing environment 100. However, for a management component upgrade, any service interruption due to the upgrade process needs to be minimized. In addition, the upgrade process should not require additional compute resources beyond the resource capacity of the computing environment 100, which can add to the cost operating the computing environment 100.

As described in more detail below, in the computing environment 100, a management component, e.g., the VCM 130, is upgraded using a new upgraded management component deployed in the computing environment without using any additional resources of the computing environment. In addition, the upgrade process uses an HA-related mechanism to ensure that, in case of a failure, the original management component or the new upgraded management component is failed over depending on the state of the upgrade process when the failure occurred. If the failure occurs before an HA switchover phase of the upgrade process, only the original management component is failed over or restarted on another host in the computing environment 100. However, if the failure occurs after the HA switchover phase of the upgrade process, only the new upgraded management component is failed over or restarted on another host in the computing environment 100. The HA switchover phase of the upgrade process is described in detail below. Although embodiments of the invention may be applied to any management component in a computing environment using any virtual computing instances, the upgrade process is described herein for a virtual cluster manager, such as the VCM 130, which is implemented in a VM. Thus, in this disclosure, the term “VCM” and “VCM VM” may sometimes be used interchangeably.

In accordance with embodiments of the invention, in the computing environment 100, the VCM 130 is upgraded by first deploying an upgraded version of the VCM, which will take over the responsibilities of the original VCM, e.g., services provided by the original VCM. In this disclosure, the original VCM being upgraded will be referred to herein as the source VCM, while the new upgraded VCM will be referred to herein as the target VCM. The target VCM is deployed in a chunk or slot of resources, e.g., compute, memory and/or storage resources, provided by one of the hosts 104, that is reserved for failover of management VMs, e.g., the VM with the VCM 130.

The resource chunk is part of failover capacity reserved for management VMs by the resource scheduling system for the HA system in the computing environment 100 through an HA admission control policy, which may be specific to the public cloud in which the computing environment 100 resides. Thus, the resource chunk is provided in the computing environment as part of the resources of the failover capacity. In an embodiment, the size of the resource chunk may be selected to equal the largest management VM (typically, the VCM VM, but in some cases, the logical network manager VM). These resource chucks ensure that, given a certain failure model, capacity is available to restart (or fail over) the management appliances or VMs that are required by adding a healthy replacement host into the cluster 102. If this set of critical management appliances is available, then the reserved capacity can be used to restart other management VMs. When all management VMs are available, any remaining reserved capacity can be used for customer VMs. The addition of replacement host or hosts ensures that, in the end, cluster capacity gets restored and all VMs can be restarted. In the event of a failure, the HA system in the computing environment 100 fails over all the affected powered-on VMs by default unless it is configured to ignore any. The VMs which the HA system will attempt to fail over are called “protected VMs”, which are recorded in a VM protection list on a shared datastore by the HA system. This shared datastore is accessible by all the hosts in the cluster 102 so that the HA system can fail over every protected VM to another host with sufficient capacity.

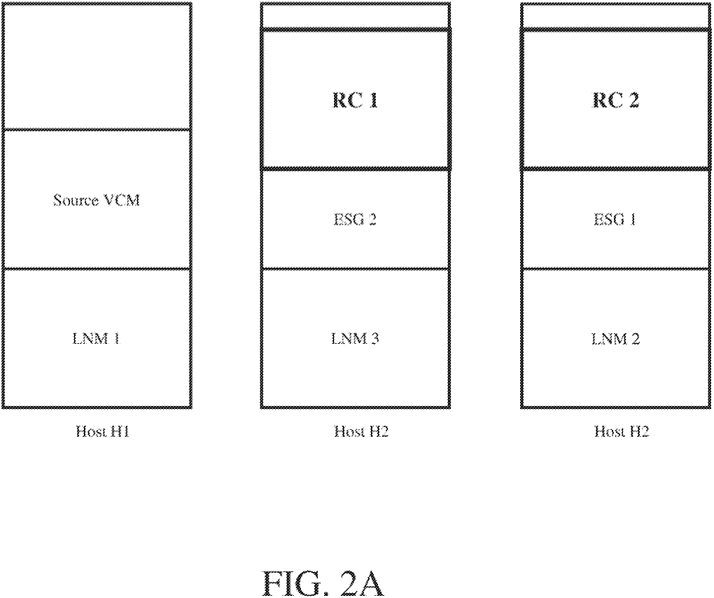

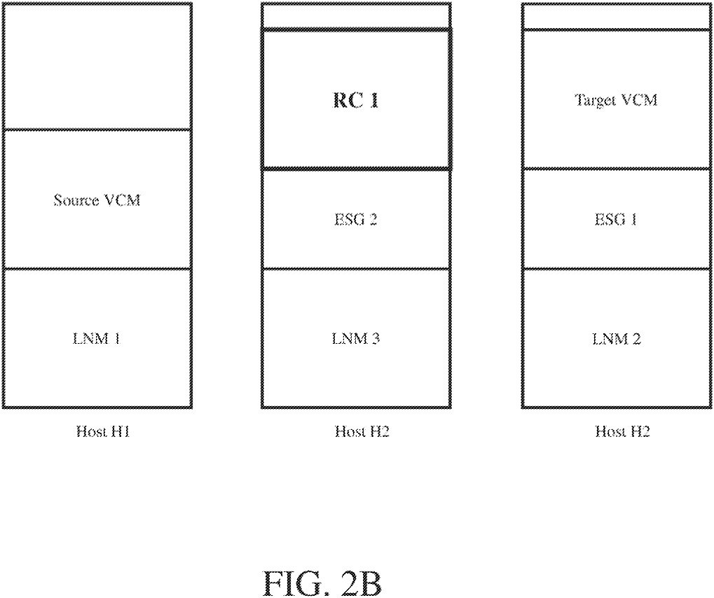

FIGS. 2A and 2B illustrate resource chunks that can be used to deploy a target VCM VM in accordance with an embodiment of the invention. In FIG. 2A, resource capacities of host H1, host H2 and host H3 in a three-node cluster are shown. As shown in FIG. 2A, the resource capacity of the host H1 is used by a source VCM VM and a logical network manager LNM1. The resource capacity of the host H2 is used by a resource chuck RC1, an edge services gateway ESG2 and a logical network manager LNM3. The resource capacity of the host H3 is used by a resource chuck RC2, an edge services gateway ESG1 and a logical network manager LNM2. In this three-node cluster, there are two resource chunks, which are the resource chunk RC1 and the resource chunk RC2. Thus, a target VCM VM may be deployed in the resource chunk RC1 or the resource chunk RC2. As an example, FIG. 2B illustrates the three-node cluster when the target VCM VM is deployed in the resource chunk RC2, which is already part of a failover capacity reserved for management VMs by the resource scheduling system for the HA system in a computing environment. Thus, no additional resources are needed in the three-node cluster for the deployment of the target VCM VM. In an embodiment, the target VCM VM is deployed as an HA preemptible VM, which is a VM that can use the resource chunk, i.e., a set amount of resources reserved from the HA spare capacity. An HA preemptible VM can be preempted, i.e., powered off, to reclaim the HA spare capacity in the event of a host failure.

The VCM upgrade process in accordance with embodiments of the invention also include steps to set the target VCM VM as an HA unprotected VM once the target VCM VM is deployed. However, the source VCM VM is left unchanged as an HA protected VM so that only the source VCM VM is failed over if there is a host failure. In an embodiment, the source and target VCM VMs are set as an initial primary-secondary management VM preemptive pair, where the source VCM VM is set as a primary protected VM and the target VCM VM is set as a secondary unprotected preemptible VM.

The VCM upgrade process in accordance with embodiments of the invention further include steps to switch the target VCM VM to an HA protected VM and the source VCM VM to an HA unprotected VM, just before the target VCM takes over the services of the source VCM. Thus, after this point in the VCM upgrade process, only the target VCM VM is failed over if there is a host failure. In an embodiment, the source and target VCM VMs are set as a switched primary-secondary management VM preemptive pair, where the target VCM VM is set as the primary protected VM and the source VCM VM is set as the secondary unprotected preemptible VM.

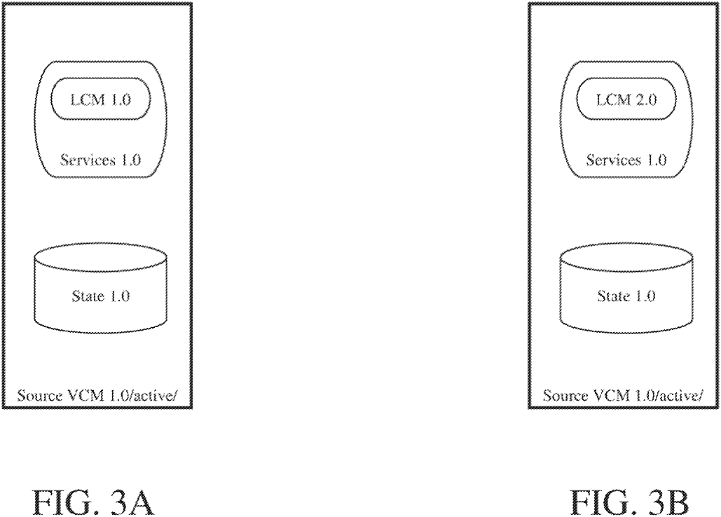

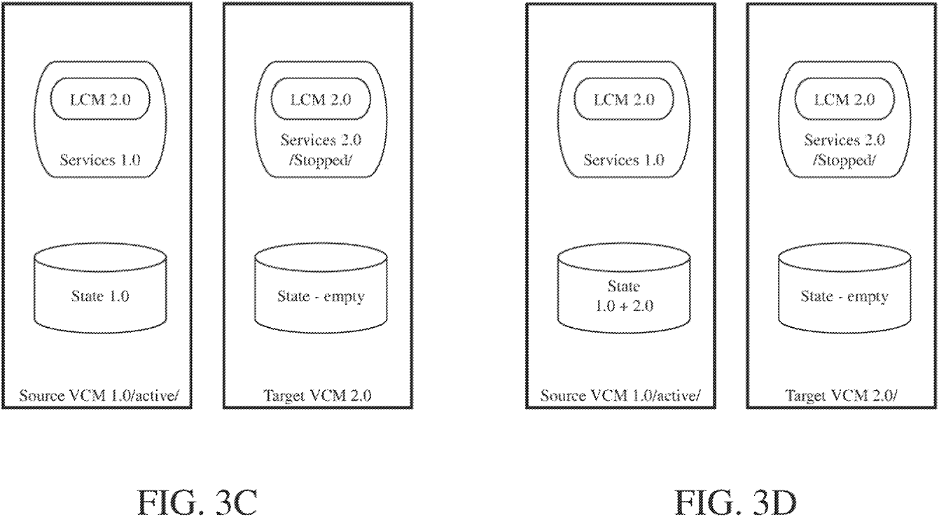

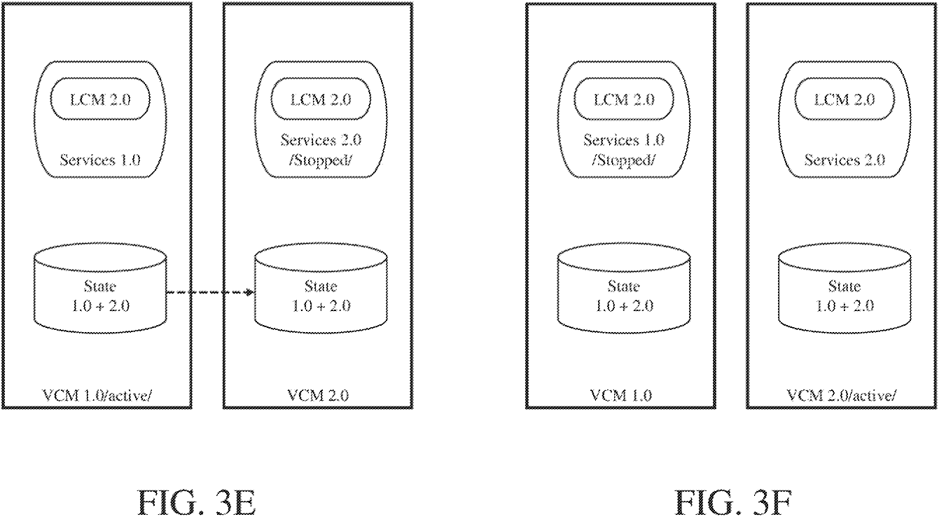

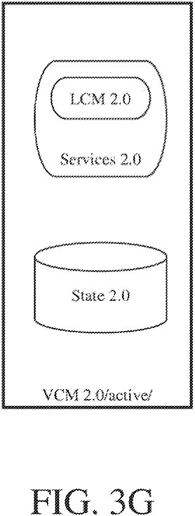

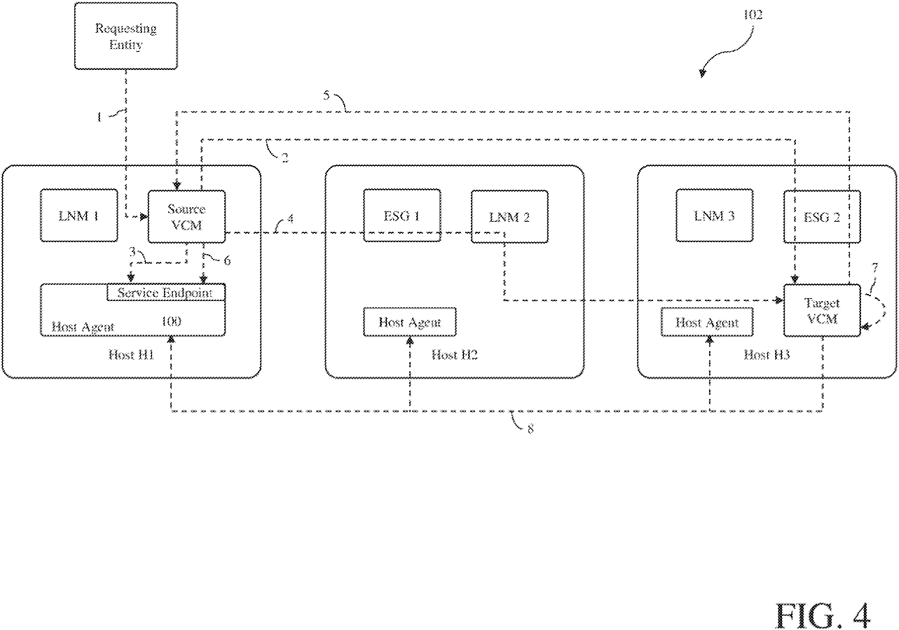

The process of upgrading the VCM 130 in the computing environment 100 in accordance with an embodiment of the invention is described with reference to FIGS. 3A-3G and 4. FIGS. 3A-3G illustrate the source VCM 130, i.e., the original VCM that is being upgraded, and a target VCM, i.e., the new version VCM, during the VCM upgrade process in accordance with an embodiment of the invention. In FIGS. 3A-3G, the version number “1.0” is used to indicate the original version, while the version number “2.0” is used to indicate the new or upgraded version. FIG. 4 illustrates the various components of a three-node cluster 102 in the computing environment 100 that are involved in the VCM upgrade process in accordance with an embodiment of the invention. The three-node cluster shown in FIG. 4 is the same three-node cluster shown in FIGS. 2A and 2B. The VCM upgrade process can be visualized as being executed in the following six phases: (1) upgrade the patcher (LCM service of the source VCM) phase; (2) deploy the target VCM phase; (3) expand phase; (4) replicate phase (data copy from source VCM to target VCM); (5) switchover phase; and (6) contract phase.

Initially, the computing environment 100 has only the source VCM, which has services 1.0, including the LCM service 1.0, and state information 1.0, as illustrated in FIG. 3A. The upgrade the patcher phase of the VCM upgrade process is first executed in the computing environment 100. In this phase, the VCM upgrade process is triggered or initiated by a requesting entity, which can be a user using a user interface (UI) or a software process running in the computing environment or in another computing environment, such as a management computing environment of a cloud service provider, as indicated by the arrow 1 in FIG. 4,. Also in this phase, the LCM service 1.0 of the source VCM is patched to a new version 2.0, as illustrated in FIG. 3B.

Next, the deploy the target VCM phase of the VCM upgrade process is executed. In this phase, the target VCM is deployed as a VM such that the target VCM VM is placed in the resource chunk RC2 reserved for HA failover in the host H3 by the source VCM VM, with help from the resource scheduling system in the computing environment 100, as indicated by the arrow 2 in FIG. 4,. Thus, no additional resources are utilized by the target VCM VM, thereby sparing critical resources for customer’s workload VMs. The source VCM VM and the target VCM VM are set as a primary-secondary management VM preemptive pair. In particular, the source VCM VM will remain as an HA protected VM and the target VCM VM is set as an HA unprotected VM. If an HA protected VM has some issues, the HA system in the computing environment 100 will try to fail over the VM (i.e., restart in another host). However, if an HA unprotected VM has some issues, the HA system will not fail over the VM. The deployment of the target VCM VM is also illustrated in FIG. 3C, which shows the target VCM with services 2.0 (stopped) and empty state information. Additionally in this phase, the HA system is directed to store the primary-secondary management VM preemptive pair by the LCM service of the source VCM VM, as indicated by the arrow 3. In an embodiment, this is achieved by communicating with the HA agent of the host H1 via a service endpoint of that HA agent, which is used to transmit information regarding the source and target VCMs.

Next, the expand phase of the VCM upgrade process is executed. In this phase, the state information 2.0 for the target VCM is added to the source VCM to prepare for the next phase, as illustrated in FIG. 3D.

Next, the replicate phase of the VCM upgrade process is executed. In this phase, data synchronization from the source VCM to the target VCM is triggered by the target VCM, as indicated by the arrow 4 in FIG. 4. In other words, the transfer/copy of all the data needed for the upgrade from the source VCM to the target VCM is orchestrated by the target VCM. In an embodiment, the services that continue to update data that needs to be copied (e.g., vpxd service) is stopped on the source VCM for the data synchronization to complete. The replicate phase is illustrated in FIG. 3E, which shows the state information 1.0 + 2.0 in the source VCM being copied to the target VCM. The target VCM is ready to take over the operation and responsibilities of the source VCM once the data synchronization is complete.

Next, the switchover phase of the VCM upgrade process is executed. In this phase, a shutdown of the source VCM is triggered or initiated by the target VCM, as indicated by the arrow 5 in FIG. 4. Next, before the source VCM is shut down, the primary-secondary management VM preemptive pair is switched with respect to the HA statuses of the source and target VCM VMs by the source VCM as indicated by the arrow 6 in FIG. 4. That is, the HA status of the source VCM VM is switched from the HA protected VM to the HA unprotected VM, and the HA status of the target VCM VM is switched from the HA unprotected VM to the HA protected VM. In an embodiment, the switching of the HA statuses of the source and target VCM VMs is an atomic process. In this embodiment, an asynchronous call to the HA agent of the host H1 via the service endpoint of that HA agent is triggered by the source VCM to atomically switch over the HA information of the source and target VCM VMs. Once the HA statuses of the source and target VCM VMs have been switched, the shutdown process of the source VCM is continued until completed. Next, the database of the target VCM is cleaned up to remove the primary-secondary management VM preemptive pair for the source and target VCM VMs from the database by the target VCM, as indicated by the arrow 7 in FIG. 4.

Next, the contract phase of the VCM upgrade process is executed. In this phase, once the source VCM is determined to be down by the target VCM, steps are triggered or initiated by the target VCM to take over as the new VCM in charge of the cluster 102. As an example, these steps may include making final modification to the database of the target VCM, taking over the internet protocol (IP) address of the source VCM, updating the logical network manager 124 and starting VCM services. In addition, the HA agents 128 in the hosts H1, H2 and H3 in the cluster 102 are upgraded by the target VCM, as indicated by the arrows 8 in FIG. 4. After the upgrade of the HA agents, a cleanup of the HA agent upgrade information is triggered or initiated by the target VCM, which completes that VCM upgrade process

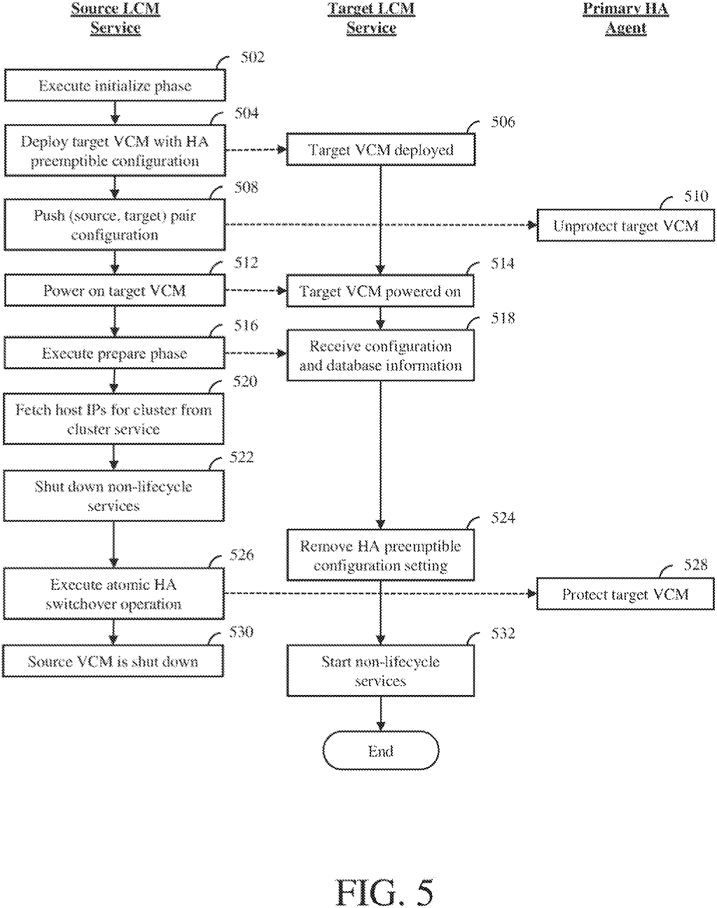

The process of upgrading the VCM 130 in the computing environment 100 in accordance with an embodiment of the invention is further described with reference to FIG. 5, which show what is occurring at the LCM service of the source VCM (referred to herein as the “source LCM service”), the LCM service of the target VCM (referred to herein as the “target LCM service”), and the primary HA agent. In FIG. 5, the source LCM service is the upgraded version of the original source LCM service.

At block 502, the initialize phase is executed by the source LCM service in response to an initialize API call from the requesting entity, which can be a user using a user interface or a software process running in the computing environment or in another computing environment, such as a management computing environment of a cloud service provider. As an input to this API, an initialization specification is passed over to the source LCM service. The initialization specification contains various parameters for the VCM upgrade process, such as, if the source VCM is to be shut down after the upgrade and where should the target VCM be deployed. The following is an example of the initialization specification that may be used:

{
“version”: “7.0.2”,
“deployment”: {
“appliance”: {
“name”: “Upgraded_VC”,
“size”: “MEDIUM”,
“disk_size”: “REGULAR”,
“thin_disk_mode”: true,
“root_password”: “Ca$hcOwl”,
“ova_info”: {
“location”: “https:.../VMware-vCenter-Server-Appliance-7.0.3.00000-
47754205_OVF10.ova”,
“ssl_verify”: false
}, “storage_size”: “REGULAR”
}, “location”: {
“vcenter”: {
“placement_config”: {
“cluster_path”: “/Datacenter/host/Cluster”,
“datastore_name”: “local-0”,
“network_name”: “VM Network”
}}}
},
“answers”: {
},“vmdir.password”: “Ca$hc0w1”
“source_shutdown_policy”: “NO_SHUTDOWN”,
“cancellation_policy”: {
“automatic”: true,
“source_connection”: {
“ip_address”: “10.78.172.183”,
}}} “connection_type”: “DIRECT”

Blocks 504-514 are part of the stage phase of the VCM upgrade process that includes an HA initialize process executed by the source LCM service. At block 504, an operation is executed by the source LCM service to deploy the target VCM VM with a preemptible configuration in response to a stage API from the requesting entity. In an embodiment, the target VCM VM is deployed with a temporary IP. Other parameters are set according to the initialization specification. However, at this point, the target VCM VM does not contain data configured in the source VCM by the user, which is stored in the configuration files and the database of the source VCM. As a result, the target VCM VM with the target LCM service is deployed, at block 506. In an embodiment, the target VCM VM is deployed in a resource chunk of one of the hosts 104 in the cluster 102, which is part of the spare HA resource capacity reserved for failover of management VMs, such as the source VCM VM.

Next, at block 508, source-to-target information for the deployed target VCM VM is pushed to the primary HA agent from the source LCM service via the cluster service 134 of the source VCM. This source-to-target information is needed by the HA system to map the target VCM to the source VCM so that the HA system can power off the target VCM when the source VCM is shut down. The presence of a VM as a target also ensures that this VM is preemptible and is not protected by the HA system. As a result, the target VCM VM is set as an HA unprotected VM by the primary HA agent, at block 510.

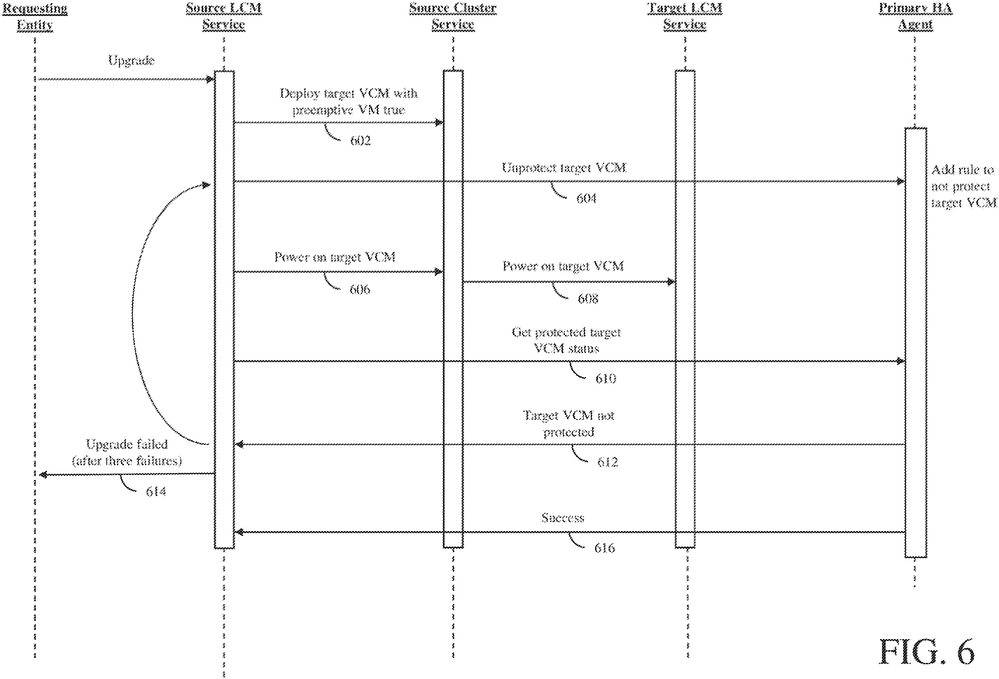

Next, at block 512, an operation to turn on the target VCM VM is executed by the source VCM. As a result, the target VCM VM is powered on, at block 514. After the target VCM VM has been powered on, the VCM upgrade process proceeds when the primary HA agent reports success to the source LCM service with respect to setting the target VCM VM as an HA unprotected VM. In an embodiment, an inquiry may be made to the primary HA agent by the source VCM service to check to see whether the target VCM VM has been successfully set as an HA unprotected VM. The HA initialize process is completed when the target VCM VM is reported as having been successfully set as an HA unprotected VM. The HA initialize process is described in more detail below with reference to FIG. 6.

Next, at block 516, the prepare phase of the VCM upgrade process is executed by the source LCM service in response to a prepare API call from the requesting entity. Execution of the prepare phase expands the data configured in the source VCM to include data needed for the target VCM and starts to synchronize this information between the source VCM and the target VCM. Thus, the prepare phase corresponds to the expand and replicate phases described above with respect to FIG. 4. As part of the data synchronization, the configuration and database information from the source VCM is received by the target VCM via the target LCM service, at block 518.

Next, at block 520, the IP addresses of the hosts 104 in the cluster 102 are fetched from the cluster service 134 of the source VCM by the source LCM service in response to a switchover API call from the requesting entity. These IP addresses are needed by the source LCM service to communicate with the host having the primary HA agent in the cluster 102 since the cluster service, which is a non-lifecycle service, will be shut down soon. Then, at block 522, non-lifecycle services at the source VCM, such as the cluster service (e.g., vxpd service), appliance management service, authentication service, certificate service, lookup service, security token service, etc., are shut down by the source LCM service.

Next, at block 524, the configuration setting for HA preemptible option is removed from the database of the target VCM VM by the target LCM service in response to instructions from the source LCM service. In an embodiment, the configuration setting for HA preemptible option is a flag in the database of the target VCM VM.

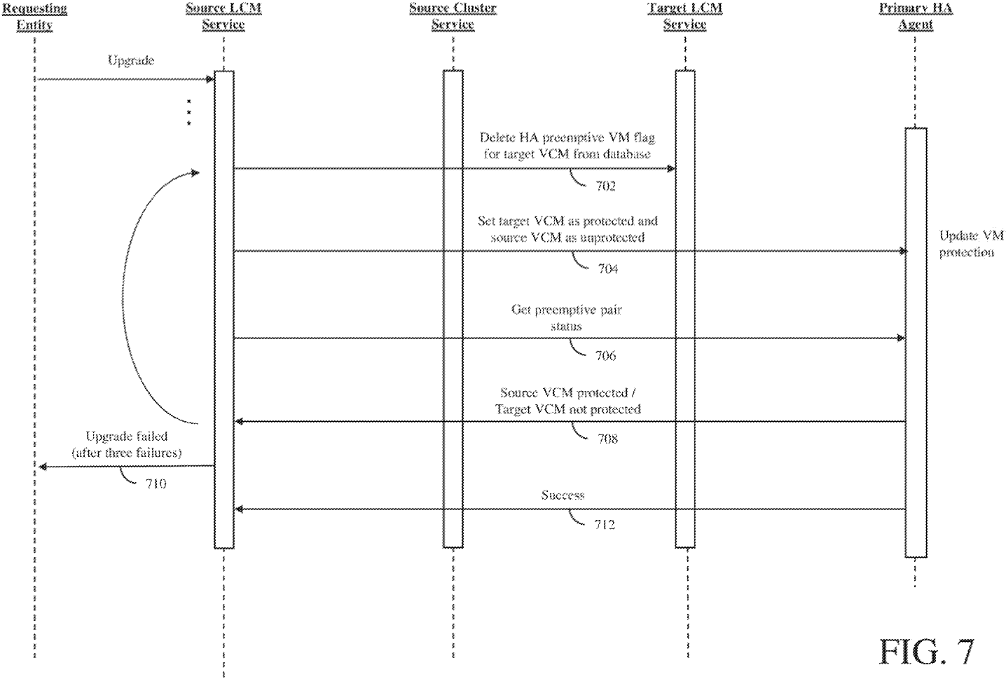

Next, at block 526, an atomic HA switchover operation is executed by the source LCM service. The atomic HA switchover operation includes resetting the restart priority for the target VCM VM from the HA unprotected VM status to the HA protected VM status and resetting the restart priority for the source VCM VM from the HA protected VM status to the HA unprotected VM status. As part of this operation, a request to run HA switchover is transmitted to the primary HA agent from the source LCM service. In response to the request, the source VCM VM is switched to the HA unprotected VM status and the target VCM VM is switched to the HA protected VM status by the primary HA agent, at block 528. In an embodiment, this operation performed by the primary HA agent may involve removing the source VCM VM from the VM protected list and adding the target VCM VM to the VM protected list. The VCM upgrade process proceeds when the primary HA agent reports success to the source LCM service with respect to switching the target VCM VM to the HA protected VM status. In an embodiment, an inquiry may be made to the primary HA agent by the source LCM service to check whether the target VCM VM has been successfully set as an HA protected VM. The HA switchover process is completed when the target VCM VM is reported as having been successfully set as an HA protected VM. The HA switchover process is described in more detail below with reference to FIG. 7.

Next, at block 530, the source VCM VM is shut down by the target VCM. In some embodiments, the source VCM VM may be deleted after it has been shut down. At block 532, the non-lifecycle services of the target VCM are started by the target LCM service to take over the services that were previously provided by the source VCM, which means that the VCM of the computing environment has been successfully upgraded. The successful upgrade of the VCM of the computing environment may be notified to the requesting entity by the target LCM service. The upgrade process then comes to an end.

Turning now to FIG. 6, a flow diagram illustrating the HA initialize workflow in accordance with an embodiment of the invention is shown. This workflow corresponds to the HA initialize process in the flow diagram of FIG. 5.

At the start of the HA initialize workflow, an instruction to deploy the target VCM VM with the HA preemptible configuration, which sets the HA preemptive VM flag as true for the target VCM VM, is sent to the source cluster service by the source LCM service, as indicated by the arrow 602. In an embodiment, the HA preemptive VM flag for the target VCM VM may be stored in shared datastore in the cluster 102 by the HA system. This configuration of the target VCM VM is passed to the DRS 136 in the source cluster service so that the resource scheduling system will treat the target VCM VM as a preemptible VM in case of host failures.

Next, an instruction is sent to the primary HA agent in the cluster 102 from the source LCM service to set the target VCM VM as an HA unprotected VM, as indicated by the arrow 604. In an embodiment, one or more API calls are made from the source LCM service to the primary HA agent to set the source VCM VM as the primary protected VM and the target VCM VM as the secondary unprotected preemptible VM, where the source and target VCM VMs are defined as a primary-secondary management VM preemptive pair. Upon receiving the instruction, a rule for the HA system is added by the target HA agent to not protect the target VCM VM. In some implementations, the protected VM list maintained by the HA system is updated by the primary HA agent to include the target VCM VM as an unprotected VM.

Next, an instruction is sent from the source LCM service to the target LCM service via the source cluster service to power on the target VCM VM, as indicated by the arrows 606 and 608. The target VCM VM is now ready to take over as the VCM for the cluster 102.

Next, as indicated by the arrow 610, an inquiry to the primary HA agent is made by the source LCM service to check whether the target VCM VM has been set properly as an HA unprotected VM. In an embodiment, an API call to the primary HA agent from the source LCM service is used to check if the primary-secondary management VM preemptive pair for the source VCM VM and the target VCM VM has been set properly. If the response from the primary HA agent states or indicates that the target VCM VM has not been set as an HA unprotected VM, i.e., the operation or setting of the primary-secondary management VM preemptive pair for the source and target VCM VMs had failed, as indicated by the arrow 612, another attempt is made to try to set the target VCM VM as an HA unprotected VM. After three (3) failure responses, the VCM upgrade process is declared to have failed, and an upgrade failure notification is transmitted to the requesting entity from the source LCM service, as indicated by the arrow 614. These retries introduce a fail-safe from a change of the primary HA agent while the source LCM service is communicating with the previous primary HA agent. However, before three (3) failures, if the response from the primary HA agent states that the target VCM VM has been set as an HA unprotected VM, the HA initialize workflow is determined by the source LCM service to have been successfully completed, as indicated by the arrow 616. The VCM upgrade process is then allowed to proceed.

Turning now to FIG. 7, a flow diagram illustrating the HA switchover workflow in accordance with an embodiment of the invention is shown. This workflow corresponds to the HA switchover process in the flow diagram of FIG. 5. The HA switchover workflow begins after the switchover phase is invoked by the source LCM service, just before triggering the source VCM VM shutdown.

At the start of the HA switchover workflow, the target LCM service is called by the source LCM service to trigger the removal of the HA preemptive VM flag from the database of the target VCM, as indicated by the arrow 702. In response, the database of the target VCM is started by the target LCM service and the entry of the HA preemptive VM flag is removed from the database.

Next, the primary HA agent is called by the source LCM service to switch the HA protected statuses of the source and target VCM VMs, as indicated by the arrow 704. Specifically, this step involves an operation for the primary HA agent to update the source VCM VM as the secondary unprotected preemptible VM and to update the target VCM VM as the primary protected VM. In a particular implementation, the operation includes removing the source VCM VM from the protected VM list and adding the target VCM VM to the protected VM list.

Next, primary HA agent is called by the source LCM service to get the status of the primary-secondary management VM preemptive pair of the source and target VCM VMs to check if the primary-secondary management VM preemptive pair for the source and target VCM VMs has been modified properly, as indicated by the arrow 706. If the response from the primary HA agent shows or indicates that the primary-secondary management VM preemptive pair for the source and target VCM VMs has not been modified properly, as indicated by the arrow 708, another attempt is made to try to properly modify the primary-secondary management VM preemptive pair for the source and target VCM VMs. After three (3) failure responses, the VCM upgrade process is declared to have failed, and an upgrade failure notification is transmitted to the requesting entity from the source LCM service, as indicated by the arrow 710. However, before three (3) failures, if the response from the primary HA agent show that the primary-secondary management VM preemptive pair for the source and target VCM VMs has been modified properly, as indicated by the arrow 712, the HA switchover workflow is determined by the source LCM service to have been successfully completed.

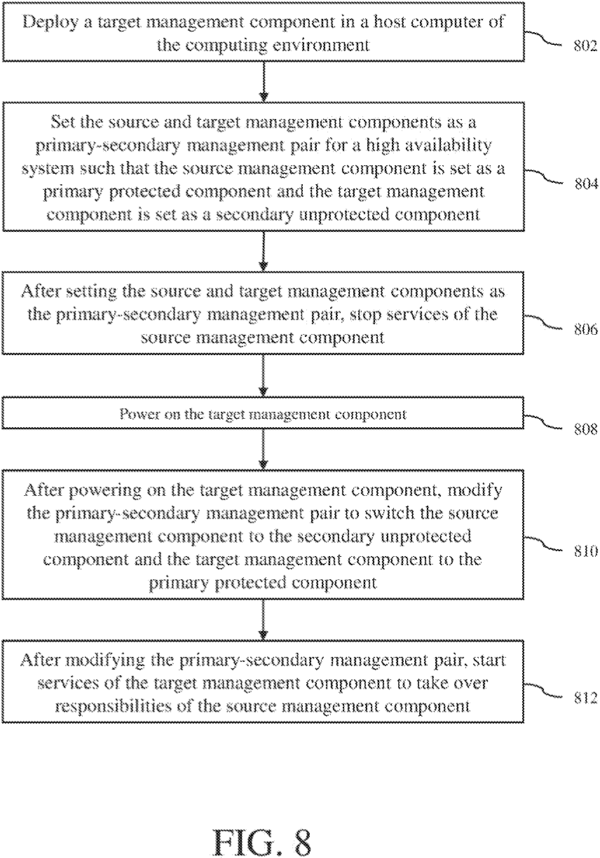

A computer-implemented method for upgrading a source management component of a computing environment in accordance with an embodiment of the invention is described with reference to a flow diagram of FIG. 8. At block 802, a target management component is deployed in a host computer of the computing environment. At block 804, the source and target management components are set as a primary-secondary management pair for a high availability system such that the source management component is set as a primary protected component for the high availability system and the target management component is set as a secondary unprotected component for the high availability system. At block 806, after setting the source and target management components as the primary-secondary management pair, services of the source management component are stopped. At block 808, the target management component is powered on. At block 810, after powering on the target management component, the primary-secondary management pair is modified to switch the source management component to the secondary unprotected component and the target management component to the primary protected component. At block 812, after modifying the primary-secondary management pair, services of the target management component are started to take over responsibilities of the source management component.

The embodiments of the invention described herein are also applicable to hybrid clouds and multi-cloud environments as well. The upgrade can be enabled to use the optimized deployment using HA slots for target deployment by a capability API. Once the upgrade is enabled, the source VCM can take care of where to deploy the target VCM, based on user parameters passed to the source VCM. In a hybrid cloud, the source VCM can be located on-premises of the hybrid cloud and the target VCM can be deployed in the public cloud of the hybrid cloud and vice versa as long as both the on-premises cluster and the public cloud cluster are in the same domain and are managed by the same VCM. In a multi-cloud environment, the source VCM can be located in one cloud and the target VCM can be deployed in another cloud as long as the clusters on both of the clouds are managed by a single VCM.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random-access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for upgrading a source management component of a computing environment, the method comprising:
deploying a target management component in a host computer of the computing environment;
setting the source and target management components as a primary-secondary management pair for a high availability system such that the source management component is set as a primary protected component for the high availability system and the target management component is set as a secondary unprotected component for the high availability system;
after setting the source and target management components as the primary-secondary management pair, stopping services of the source management component;
powering on the target management component;
after powering on the target management component, modifying the primary-secondary management pair to switch the source management component to the secondary unprotected component and the target management component to the primary protected component; and
after modifying the primary-secondary management pair, starting services of the target management component to take over responsibilities of the source management component.

2. The computer-implemented method of claim 1, wherein deploying the target management component in the host computer of the computing environment includes placing the target management component in a chunk of resources that is already part of a failover capacity reserved for management components for the high availability system in the computing environment.

3. The method of claim 2, wherein the size of the chunk of resources is selected to be equal to the largest management component in the computing environment.

4. The computer-implemented method of claim 1, wherein setting the source and target management components as the primary-secondary management pair for the high availability system includes setting the source and target management components as the primary-secondary management pair for the high availability system such that the target management component is set as a secondary unprotected preemptible component for the high availability system.

5. The computer-implemented method of claim 1, wherein deploying the target management component in the host computer of the computing environment includes deploying the target management component with a configuration to set a preemptive virtual computing instance flag as true for the target management component so that a resource scheduling system treats the target management component as a preemptible virtual computing instance.

6. The method of claim 1, further comprising, after setting the source and target management components as the primary-secondary management pair and before stopping the services of the source management component, making an inquiry to a high availability agent of the high availability system in the computing environment for a status of the primary-secondary management pair, and continue upgrading the source management component only if the status of the primary-secondary management pair indicates that the source management component is set as the primary protected component for the high availability system and wherein the target management component is set as the secondary unprotected component for the high availability system.

7. The computer-implemented method of claim 1, wherein further comprising, after modifying the primary-secondary management pair and before starting the services of the target management component, making an inquiry to a high availability agent of the high availability system in the computing environment for a status of the primary-secondary management pair, and continue upgrading the source management component only if the status of the primary-secondary management pair indicates that the source management component is set as the secondary unprotected component for the high availability system and wherein the target management component is set as the primary protected component for the high availability system.

8. The computer-implemented method of claim 1, wherein the source management component is a virtualization cluster manager that manages a cluster of host computers and virtual computing instances running on the host computers of the cluster.

9. A non-transitory computer-readable storage medium containing program instructions for upgrading a source management component of a computing environment, wherein execution of the program instructions by one or more processors of a computer system causes the one or more processors to perform steps comprising:
deploying a target management component in a host computer of the computing environment;
setting the source and target management components as a primary-secondary management pair for a high availability system such that the source management component is set as a primary protected component for the high availability system and the target management component is set as a secondary unprotected component for the high availability system;
after setting the source and target management components as the primary-secondary management pair, stopping services of the source management component;
powering on the target management component;
after powering on the target management component, modifying the primary-secondary management pair to switch the source management component to the secondary unprotected component and the target management component to the primary protected component; and
after modifying the primary-secondary management pair, starting services of the target management component to take over responsibilities of the source management component.

10. The non-transitory computer-readable storage medium of claim 9, wherein deploying the target management component in the host computer of the computing environment includes placing the target management component in a chunk of resources that is already part of a failover capacity reserved for management components for the high availability system in the computing environment.

11. The non-transitory computer-readable storage medium of claim 10, wherein the size of the chunk of resources is selected to be equal to the largest management component in the computing environment.

12. The non-transitory computer-readable storage medium of claim 9, wherein setting the source and target management components as the primary-secondary management pair for the high availability system includes setting the source and target management components as the primary-secondary management pair for the high availability system such that the target management component is set as a secondary unprotected preemptible component for the high availability system.

13. The non-transitory computer-readable storage medium of claim 9, wherein deploying the target management component in the host computer of the computing environment includes deploying the target management component with a configuration to set a preemptive virtual computing instance flag as true for the target management component so that a resource scheduling system treats the target management component as a preemptible virtual computing instance.

14. The non-transitory computer-readable storage medium of claim 9, wherein the steps further comprise, after setting the source and target management components as the primary-secondary management pair and before stopping the services of the source management component, making an inquiry to a high availability agent of the high availability system in the computing environment for a status of the primary-secondary management pair, and continue upgrading the source management component only if the status of the primary-secondary management pair indicates that the source management component is set as the primary protected component for the high availability system and wherein the target management component is set as the secondary unprotected component for the high availability system.

15. The non-transitory computer-readable storage medium of claim 9, wherein the steps further comprise, after modifying the primary-secondary management pair and before starting the services of the target management component, making an inquiry to a high availability agent of the high availability system in the computing environment for a status of the primary-secondary management pair, and continue upgrading the source management component only if the status of the primary-secondary management pair indicates that the source management component is set as the secondary unprotected component for the high availability system and wherein the target management component is set as the primary protected component for the high availability system.

16. The non-transitory computer-readable storage medium of claim 9, wherein the source management component is a virtualization cluster manager that manages a cluster of host computers and virtual computing instances running on the host computers of the cluster.

17. A system comprising:
memory; and
at least one processor configured to:
deploy a target management component in a host computer of a computing environment, wherein the computing environment includes a source management component;
set the source and target management components as a primary-secondary management pair for a high availability system such that the source management component is set as a primary protected component for the high availability system and the target management component is set as a secondary unprotected component for the high availability system;
after the source and target management components are set as the primary-secondary management pair, stop services of the source management component;
power on the target management component;
after the target management component is powered on, modify the primary-secondary management pair to switch the source management component to the secondary unprotected component and the target management component to the primary protected component; and
after the primary-secondary management pair is modified, start services of the target management component to take over responsibilities of the source management component.

18. The system of claim 17, wherein the at least one processor configured to place the target management component in a chunk of resources that is already part of a failover capacity reserved for management components for the high availability system in the computing environment when the target management component is deployed.

19. The system of claim 17, wherein the at least one processor configured to set the source and target management components as the primary-secondary management pair for the high availability system such that the target management component is set as a secondary unprotected preemptible component for the high availability system.

20. The system of claim 17, wherein the at least one processor configured to deploy the target management component with a configuration to set a preemptive virtual computing instance flag as true for the target management component so that a resource scheduling system treats the target management component as a preemptible virtual computing instance.
